(19) United States
(12) Patent Application Publication
(10) Pub. No.: US 2006/0183081 A1
(43) Pub. Date: Aug. 17, 2006

(54) Tooth bleaching system and method

(76) Inventors: Al Bevilacqua, Naperville, IL (US); Hugh Palmer, Wayne, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/236,874

(22) Filed: Sep. 27, 2005

Related U.S. Application Data
(60) Provisional application No. 60/613,608, filed on Sep. 27, 2004.

(51) Int. Cl. A61C 5/00

(52) U.S. Cl. 433/215; 433/217.1

(57) ABSTRACT

A method of and composition for bleaching teeth is provided. The composition includes a methacrylate and a bleaching agent homogeneously mixed together. The method includes sealing the dentinal tubules of the teeth to be bleached to reduce the sensitivity of the teeth to be bleached; and applying a bleaching agent that includes an oxidative agent to a surface of the teeth to be bleached. The composition includes a composition including a methacrylate and a bleaching agent mixed together.

### CROSS-REFERENCE TO RELATED APPLICATIONS

This application claims priority from U.S. Provisional Application No. 60/613,608, filed Sep. 27, 2004.

### TECHNICAL FIELD

The invention relates to compositions for and methods of bleaching teeth. More particularly, the invention is directed to a desensitizing agent and a bleaching agent. The desensitizing agent helps to reduce the patient discomfort that is typically associated with bleaching teeth. The invention also relates to the sealing of teeth which reduces rebound.

### BACKGROUND OF THE INVENTION

Generally, people prefer whiter teeth to darker teeth. However, many people's teeth, for a variety of reasons including genetics, diet, medications and environment, are not as bright white as they desire. Accordingly, numerous people desire to bleach their teeth in order to promote brighter write teeth and improve their aesthetic appearance.

Bleaching of teeth can be performed either at a dentist's or other oral-healthcare provider's office, or at home. Bleaching is commonly accomplished through the application of an oxidizing agent such as a peroxide to the teeth. In order to bleach the teeth effectively, an oxidative agent must be used as a bleaching agent in a certain strength. The required strength of these bleaching agents often causes irritation and pain to the teeth of the patient. This discomfort usually occurs a short time period after the bleaching procedure is completed.

Typically, re-hydration of the teeth, reformation of biofilm and increased susceptibility to staining immediately after bleaching cause rebound. Rebound is where the teeth quickly increase shade, thereby darkening, within the first two weeks after a whitening treatment. In many cases, a significant portion of the whitening benefit can be eroded by rebound. The term “rebound” as used herein is an increase in measurable shade from time of completion of procedure as compared with measurement in the next two weeks. To measure the shade, it is understood that one can use the Vita Shade Guide or other standard used to measure shade of teeth.

A need exists to reduce the pain and irritation to the teeth of a patient who desires to bleach his or her teeth.

A need also exists to use a stronger bleaching agent to more effectively bleach teeth without substantial pain for the patient.

A further need exists to use a higher concentration of the bleaching agent to more effectively bleach teeth without substantial pain for the patient.

A need exists to have the bleaching agent contact the surface of the teeth for a longer duration to more effectively bleach teeth without substantial pain for the patient.

A need also exists to substantially maintain the share of the teeth for an extended period of time after bleaching.

The present invention is provided to solve one or more of the problems discussed above and other problems, and to provide advantages and aspects not provided by prior art of this type. A full discussion of the features and advantages of the present invention is deferred to the following detailed description.

### SUMMARY OF THE INVENTION

In one embodiment of the present invention, a method for bleaching teeth including dentinal tubules is provided. This method includes applying a bleaching agent comprising an oxidative agent to a surface of the teeth to be bleached. The method also includes sealing the dentinal tubules of the teeth to be bleached by use of a desensitizing agent to reduce the sensitivity of the teeth to be bleached.

In another embodiment of the present invention, a method of bleaching teeth to a whiter color is provided. This method includes applying a bleaching agent to brighten the teeth to a brighter color, and sealing the teeth. In this method, the teeth with the brighter color retain their shade to a measurable degree for 2 weeks relative to untreated teeth surfaces.

In yet another embodiment of the present invention, a tooth whitening and desensitizing formulation is provided. The formulation includes a methacrylate and a bleaching agent homogeneously mixed together.

Other features and advantages of the invention will be apparent from the following specification.

### BRIEF DESCRIPTION OF DRAWINGS

To understand the present invention, it will now be described by way of example, with reference to the accompanying drawing in which:

FIG. 1 is a flowchart of one embodiment of the present invention.

### DETAILED DESCRIPTION

While this invention is susceptible of embodiments in many different forms, there will herein be described in detail preferred embodiments of the invention with the understanding that the present disclosure is to be considered as an exemplification of the principles of the invention and is not intended to limit the broad aspect of the invention to the embodiments illustrated.

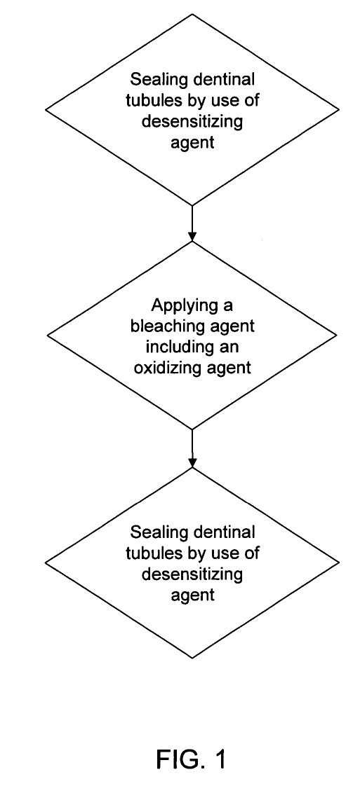

Generally, as shown in FIG. 1, the present invention provides a method and composition for aiding in the effective bleaching of teeth of a person. Specifically, a desensitizing agent is applied both before and after a bleaching agent is applied. Alternatively, the desensitizing agent may be applied either before or after a bleaching agent is applied, but not both. According to the invention, a person desires to whiten or bleach some or all of his or her teeth. The teeth are cleaned thoroughly with prophy paste. The presence of calculus may require scaling. Optionally, the gingival tissue may be protected by the use of a rubber dam or mask, cotton pellets or other technique as known in the art. The bleaching is accomplished through application of a bleaching agent applied directly to the teeth. Alternately, a bleaching agent may be added to a preformed tray and placed on the teeth. After the bleaching agent is removed, the teeth are rinsed with water. If the rubber dam or mask was utilized, it is now removed. In one embodiment, the teeth are subsequently desensitized using a desensitizing agent. This reduces the pain of the person, and thus permits the teeth to be bleached more thoroughly and less painfully than without the desensitizing agent. For example, a stronger bleaching agent, a higher concentration of a bleaching agent or a larger contact time with the tooth surface may be used because the teeth are or will be desensitized.

After application of the bleaching agent and desensitizer, applicants have found an unexpected result. Two weeks following the bleaching procedure, there is typically only a smaller, measurable shade rebound in tooth color than in surfaces not treated with the present invention. The difference between use of the present invention and untreated surfaces may be 50% or greater, and the total rebound may be, for example, ½ a shade. This minimal rebound can occur by the use of any surface sealant or methacrylate or oxalate-based sealant. For example, hema products (such as Gluma or HemaSeal&Cide), amorphous calcium phosphate or oxalates (such as SuperSeal™) can be used in order to achieve this reduction in rebound. Hema based compounds, applied immediately prior to and following the bleaching procedure, can reduce sensitivity and rebound simultaneously. While not wishing to be bound by theory, applicants believe that in the case of hema-based products, the use of monomers to polymerize or co-polymerize on the tooth surface as well as in the dentin causes such results. A preferred formulation is hema, water, an anti-microbial and fluoride, although other formulations are possible, as understood by those of skill in the art.

In another embodiment of the present invention, the desensitizing agent may be applied simultaneously with or before use of the bleaching agent, or may even be blended in the bleaching agent. If the desensitizing agent is applied before use of the bleaching agent, application of the bleaching agent should be delayed a sufficient period of time to permit the desensitizing agent to function.

If required, a rubber dam or mask may aid in isolating soft tissue adjacent to teeth undergoing the bleaching procedure. Preferably, it is a fast setting, self-curing vinyl silicone. The setting time may be, for example, 2 minutes intra-oral. Ideally, the dam forms a 4-6 millimeters wide strip on the gingival. If space is available, the interproximal areas should also be sealed. The dam should be placed approximately 0.5 millimeters onto dry enamel.

The present invention is adaptable to numerous different bleaching agents. Dental bleaching agents are commonly peroxides. Examples include hydrogen peroxide, carbamide peroxide (for example an 11% or 20% carbamide peroxide gel), sodium perborate, sodium percarbonate and peroxyacetic acid. When peroxides contact teeth, they usually oxidize stains leaving the teeth whiter. The amount of whitening accomplished is related to, among other things, the particular bleaching agent used, the concentration of the bleaching agent and the time the bleaching agent contacts the teeth. The required strength of these products to effectively bleach teeth has been determined to cause irritation and pain. Additionally, the whitening may be accelerated by use of chemical or light based agents to, for example, increase the temperature at the tooth surface or to facilitate a chemical reaction or breakdown of the peroxide molecule.

The bleaching agent is applied directly to the outer tooth surface. In the preferred embodiment, a sufficient amount of the bleaching agent is applied to a preformed tray to cover the outer tooth surface. The tray is then placed on the teeth. In another embodiment of the present invention, the bleaching agent may be applied through a static mixing tip directly onto the labial surface of the teeth. The syringe may be heated (for example, by being placed in hot water for 5 minutes). After application, the bleaching agent should be agitated. For example, an applicator brush can be used to agitate the bleaching agent. The bleaching agent should be agitated every 15 minutes to allow fresh product to come in contact with the tooth surface. When using a bleaching agent comprising 11% or 20% carbamide peroxide gel, the bleaching reaction will be complete after 45 minutes. After completion of the bleaching, the bleaching agent is removed. This can be accomplished by use of a cotton gauze. The bleached teeth are rinsed extremely well with copious amount of water, and preferably a high speed evacuator. If the rubber dam or mask was used, it is removed at this time.

The desensitizing agent of the present invention is similar to that described in U.S. Pat. No. 5,693,315 by the inventor of the present application. U.S. Pat. No. 5,693,315 is incorporated herein by reference. The active ingredient of the desensitizing agent is a moiety which cross links with a dental collagen to facilitate tubule sealing. One such moiety genus is the methacrylates. Applicant has found that various methacrylates are suitable for the present invention, including but not limited to hydroxyethyl methacrylate, methyl methacrylate, glycol methacrylate, and ethyl methacrylate. Surprisingly and unexpectedly, the applicants found that fluoride further facilitates cross linking. A suitable desensitizing agent contains: methacrylate, fluoride and benzylkonium chloride. Any chemical or mixture can be used so long as it is functionally equivalent. It is understood that other desensitizing agents, oxalates and amorphous calcium phosphates may have the same results.

The instant formulation generates relatively little surface tension on the tooth surface thereby facilitating easier tubule penetration and more successful bending processes. This occurs because of cross linking between the desensitizer formulation and protein within the tubules of the dentin. Depth of penetration of the desensitizing agent below the surface of the tooth varies. Typically, the inventors have found a penetration depth of between approximately 25-30 microns, and most preferably 27 microns. Generally, all that is necessary is that the penetration depth be such that the action of the desensitizer in the tubules is remote from the action of the bleaching agent. The desensitizer travels from the tooth surface to interior regions of the tubules via capillary action, osmosis or due to hydrophilic nature of chemistry in the desensitizer. It is contemplated that the dentinal tubules may be completely sealed, occluded or partially blocked.

The method of the present invention is conducted at ambient temperatures. The desensitizer is applied to the teeth. This may be accomplished by, for example, a micro-brush or a unit dose applicator. In some cases, more than one coating of the desensitizer is used. The desensitizer dries, typically by exposure to the air. It may take approximately fifteen to twenty seconds for it to dry. Additional heat may be provided through an external source, either directly or indirectly.

In severe staining cases, the bleaching agent can be reapplied.

The present invention also includes the use of hydroxyethyl methacrylate to block tubules to reduce pain caused by oxidative agents, or chemical or light based agents used to accelerate bleaching. This formulation may contain an anti-microbial. This formulation may contain fluoride, in various forms from none up to 1.2% or the maximum allowed by the Food and Drug Administration.

The present invention further includes the use of oxalates or amorphous calcium phosphate to block tubules to reduce pain caused by oxidative agents, or chemical or light based agents used to accelerate bleaching. This formulation may contain an anti-microbial. This formulation may contain fluoride, in various forms from none up to 1.2% or the maximum allowed by the Food and Drug Administration.

In another embodiment of the present invention, the desensitizing agent and the bleaching agent are present in a homogeneously mixed compound. For example, the compound may be comprised of 30% hydroxyethyl methacrylate, 1.2% fluoride, 0.5% benzalkonium chloride, and the balance being comprised of water. Use of a mixed compound is simpler to use than application of two separate components. The dental personnel need not rely on a two step application process in patient preparation. It also requires less time to apply since the patient does not need to wait until after application of the first component before applying the second component.

While the specific embodiments have been illustrated and described, numerous modifications come to mind without significantly departing from the spirit of the invention, and the scope of protection is only limited by the scope of the accompanying Claims.
What is claimed is:

1. A method for bleaching teeth including dentinal tubules comprising:
applying a bleaching agent comprising an oxidative agent to a surface of the teeth to be bleached; and
sealing the dentinal tubules of the teeth to be bleached by use of a desensitizing agent to reduce the sensitivity of the teeth to be bleached.

2. The method recited in claim 1 wherein sealing the dentinal tubules occurs after applying the bleaching agent.

3. The method recited in claim 1 wherein sealing the dentinal tubules occurs before applying the bleaching agent.

4. The method recited in claim 1 wherein sealing the dentinal tubules occurs while applying the bleaching agent.

5. The method recited in claim 1 wherein the sealing comprises applying hydroxyethyl methacrylate to the teeth to be bleached.

6. The method recited in claim 1 wherein the bleaching agent is agitated on the surface of the teeth to be bleached.

7. The method recited in claim 6 wherein bleaching agent is agitated approximately every 15 minutes until the teeth are sufficiently bleached.

8. The method recited in claim 1 wherein the sealing comprises applying oxalate to the teeth to be bleached.

9. The method recited in claim 1 wherein the sealing comprises applying amorphous calcium phosphate to the teeth to be bleached.

10. The method recited in claim 1 wherein the dentinal tubules of the teeth to be bleached are partially or wholly occluded.

11. The method recited in claim 1 wherein the oxidative agent is more concentrated than an oxidative agent tolerable without pain if the sensitivity of the teeth to be bleached had not been reduced.

12. The method recited in claim 1 wherein the oxidative agent is applied to the surface of the teeth to be bleached for a shorter duration than an oxidative agent tolerable without pain if the sensitivity of the teeth to be bleached had not been reduced.

13. The method recited in claim 1 wherein the bleaching is accelerated by use of chemical or light based agents.

14. The method recited in claim 1 wherein the desensitizing agent penetrates the teeth to be bleached to a depth of between approximately 25-30 microns.

15. The method recited in claim 1 wherein the desensitizing agent penetrates the teeth to be bleached to a depth of approximately 27 microns.

16. The method recited in claim 1 further comprising acid etching the teeth.

17. A method of reducing rebound of bleached teeth comprising:
providing bleached teeth having a color shade; and
sealing the teeth by use of a desensitizer, wherein the bleached teeth retain their color shade within a degree measurably greater than a color shade if the desensitizer had not been used.

18. The method recited in claim 17 wherein the sealing occludes the tubules.

19. The method recited in claim 17 wherein the sealing covers the tubules.

20. A tooth whitening and desensitizing formulation comprising a methacrylate and a bleaching agent homogeneously mixed together.
